(19) United States
(12) Patent Application Publication
(10) Pub. No.: US 2024/0094148 A1
(43) Pub. Date: Mar. 21, 2024

(54) X-RAY REFLECTOMETRY APPARATUS AND METHOD THEREOF FOR MEASURING THREE DIMENSIONAL NANOSTRUCTURES ON FLAT SUBSTRATE

(71) Applicant: INDUSTRIAL TECHNOLOGY RESEARCH INSTITUTE, Hsinchu (TW)

(72) Inventors: Bo-Ching HE, Hsinchu City (TW); Chun-Ting LIU, Taichung City (TW); Wei-En FU, Yangmei City (TW); Wen-Li WU, Hsinchu City (TW)

(73) Assignee: INDUSTRIAL TECHNOLOGY RESEARCH INSTITUTE, Hsinchu (TW)

(21) Appl. No.: 17/994,858

(22) Filed: Nov. 28, 2022

(30) Foreign Application Priority Data
Sep. 13, 2022 (TW) 111134541

(51) Int. Cl. G01N 23/20008; G01B 15/04

(52) U.S. Cl. CPC G01N 23/20008; G01B 15/04; G01N 2223/052; G01N 2223/3303

(57) ABSTRACT

This disclosure relates to an X-ray reflectometry apparatus and a method for measuring a three-dimensional nanostructure on a flat substrate. The X-ray reflectometry apparatus comprises an X-ray source, an X-ray reflector, a 2-dimensional X-ray detector, and a two-axis moving device. The X-ray source is for emitting X-ray. The X-ray reflector is configured for reflecting the X-ray onto a sample surface. The 2-dimensional X-ray detector is configured to collect a reflecting X-ray signal from the sample surface. The two-axis moving device is configured to control two-axis directions of the 2-dimensional X-ray detector to move on at least one of x-axis and z-axis with a formula concerning an incident angle of the X-ray with respect to the sample surface for collecting the reflecting X-ray signal.

This application claims the benefit of Taiwan application Serial No. 111134541, filed Sep. 13, 2022, the subject matter of which is incorporated herein by reference.

### TECHNICAL FIELD

The disclosure relates in general to measuring device, and more particularly to an X-ray reflectometry (XRR) apparatus and a method thereof for measuring three dimensional nanostructures on a flat substrate.

### BACKGROUND

X-ray reflectometry (XRR) is a powerful technique to investigate surfaces and interfaces including their roughness, diffuseness across buried layers and thickness of single layer and multilayer stacks by depth profiling the electron density in the direction normal to the sample surface with a sub-nanometer resolution. It has also been shown that XRR is capable of quantifying the cross section profile of surface patterns, for example, the cross section of line gratings fabricated by nanoimprint as well as the molds used to imprint the patterns.

### SUMMARY

According to one embodiment, an X-ray reflectometry (XRR) apparatus for measuring three dimensional nanostructures on a flat substrate is provided. The X-ray reflectometry apparatus comprises an X-ray source, an X-ray reflector, a 2-dimensional X-ray detector, and a two-axis moving device. The X-ray source is for emitting X-ray. The X-ray reflector is configured for reflecting the X-ray onto a sample surface. The 2-dimensional X-ray detector is configured to collect a reflecting X-ray signal from the sample surface. The two-axis moving device is configured to control two-axis directions of the 2-dimensional X-ray detector to move on at least one of x-axis and z-axis with a formula concerning an incident angle of the X-ray with respect to the sample surface for collecting the reflecting X-ray signal.

According to another embodiment, a method for an X-ray reflectometry (XRR) apparatus to measure three dimensional nanostructures on a flat substrate is provided. The method comprises the following steps. X-ray is emitted by an X-ray source. The X-ray is reflected onto a sample surface by an X-ray reflector. A reflecting X-ray signal from the sample surface is collected by a 2-dimensional X-ray detector. Two-axis directions of the 2-dimensional X-ray detector are controlled by a two-axis moving device to move on at least one of x-axis and z-axis with a formula concerning an incident angle of the X-ray with respect to the sample surface for collecting the reflecting X-ray signal.

### BRIEF DESCRIPTION OF THE DRAWINGS

FIG. 1 illustrates an X-ray reflectometry apparatus and a method for measuring a three-dimensional nanostructure on a flat substrate according to an embodiment.

FIG. 2A and FIG. 2B illustrate the X-ray reflectometry apparatus and the method for measuring the three-dimensional nanostructure on the flat substrate according to another embodiment.

FIG. 3A and FIG. 3F illustrate the X-ray reflectometry apparatus and the method for measuring the three-dimensional nanostructure on the flat substrate according to yet another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Details are given in the non-limiting embodiments below. It should be noted that the embodiments are illustrative examples and are not to be construed as limitations to the claimed scope of the present disclosure. The same/similar denotations are used to represent the same/similar components in the description below. Directional terms such as x-axis, y-axis, z-axis are used in the following embodiments to indicate the directions of the accompanying drawings, not for limiting the present invention.

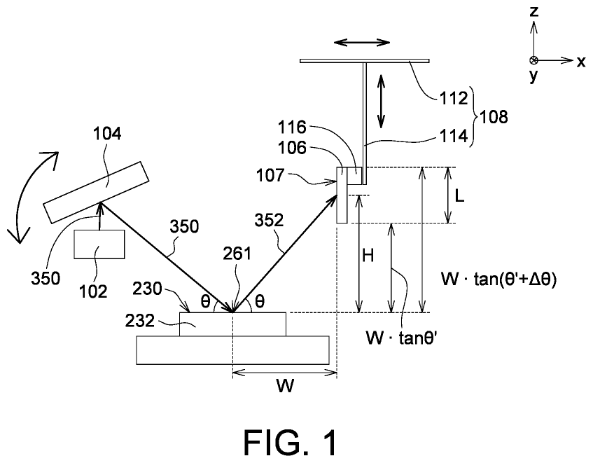

FIG. 1 illustrates an X-ray reflectometry apparatus and a method for measuring a three-dimensional nanostructure on a flat substrate according to an embodiment. The X-ray reflectometry apparatus comprises an X-ray source 102, an X-ray reflector 104, a 2-dimensional X-ray detector 106 and a two-axis moving device 108. The X-ray source 102 is used for emitting X-ray 350. The X-ray reflector 104 is configured for reflecting the X-ray 350 from the X-ray source 102 onto a sample surface 230 of the sample 232 disposed on a platform. The sample 232 is for example, a semiconductor substrate. The measuring method can be used to measure nano semiconductor structures such as a line width, a line pitch, etc. of the sample surface 230 of the sample 232. The wavelength of the X-ray 350 is no more than twice of a characteristic length along the surface normal of a structure of the sample 232. The characteristic length is selected from the group consisting of film thicknesses of the surface and heights of a nanostructure of the sample surface 230 of the sample 232. The X-ray source 102 may be used to emit the X-ray of one wavelength in a multi-wavelength range of 0.154 nm-20 nm. In an embodiment, the X-ray source 102 includes a fine focused aluminum anode. The X-ray reflector 104 can be for point focusing the X-ray 350 onto the sample surface 230. The X-ray reflector 104 may be selected from a group consisting of single crystal monochromators and multilayer mirrors. For a multilayer mirror type, the wavelength dispersion of the X-ray reflector 104 is less than 0.01. The 2-dimensional X-ray detector 106 is configured to collect a reflecting X-ray signal 352 from the sample surface 230. The incident angle of the X-ray 350 with respect to the sample surface 230 is equal to the exit angle of the reflecting X-ray signal 352 with respect to the sample surface 230. The 2-dimensional X-ray detector 106 may include a 2-dimensional X-ray sensor in a vacuum chamber and an analyzer outside the vacuum chamber, and the sensor size of the 2-dimensional X-ray sensor can collect the reflecting X-ray signal 352 completely. The 2-dimensional X-ray detector 106 has a fine pixel resolution for collecting the reflecting X-ray signal 352 (such as X-ray reflected by the sample surface 230).

The two-axis moving device 108 is configured to control two-axis directions of the 2-dimensional X-ray detector 106 to move on at least one of x-axis and z-axis with a formula concerning an incident angle of the X-ray 350 with respect to the sample surface 230 for collecting the reflecting X-ray signal 352.

The two-axis moving device 108 comprises an x-axis moving device 112 and a z-axis moving device 114. The z-axis moving device 114 is coupled between the 2-dimensional X-ray detector 106 and the x-axis moving device 112. The x-axis moving device 112 is configured to control the 2-dimensional X-ray detector 106 to move on the x-axis with a formula concerning the incident angle of the X-ray 350 with respect to the sample surface 230 for collecting the reflecting X-ray signal 352. The z-axis moving device 114 is configured to control the 2-dimensional X-ray detector 106 to move on the z-axis with a formula concerning the incident angle of the X-ray 350 with respect to the sample surface 230 for collecting the reflecting X-ray signal 352.

A rotating device 116 may be coupled between the z-axis moving device 114 and the 2-dimensional X-ray detector 106. The rotating device 116 may be configured for rotating the 2-dimensional X-ray detector 106 in x-z plane. In other words, the rotating device 116 may be configured for rotating the 2-dimensional X-ray detector 106 along the y-axis.

When the incident angle θ of the X-ray 350 with respect to the sample surface 230 is set as a range from θ′ to θ′+Δθ, the x-axis moving device 112 of the two-axis moving device 108 controls the 2-dimensional X-ray detector 106 to move on the x-axis with a formula of

$$W < \frac{L}{tan ( {θ}^{′} + Δθ ) - tan {θ}^{′}} ,$$

and at the same time the z-axis moving device 114 of the two-axis moving device 108 controls the 2-dimensional X-ray detector 106 to move on the z-axis with a formula of H=W·tan θ′+L/2, such that the reflecting X-ray signal 352 can be completely collected by the 2-dimensional X-ray detector 106 in the case of the incident angle θ being the range from θ′ to θ′+Δθ without moving the two-axis moving device 108. Δθ represents the amount of change in the incident angle.

In the present disclosure, W is a distance between a X ray-reflection point 261 on the sample surface 230 and a surface 107 of the 2-dimensional X-ray detector 106 along the x-axis. L is a size (e.g. height) of the 2-dimensional X-ray detector 106 along the z-axis. H is a distance between the sample surface 230 and the center of the 2-dimensional X-ray detector 106 along the z-axis.

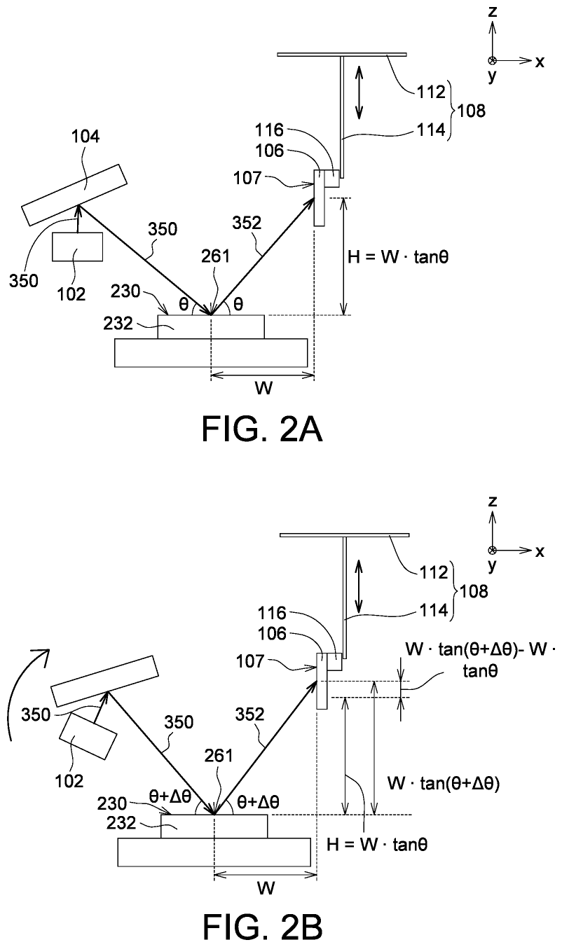

FIG. 2A and FIG. 2B illustrate the X-ray reflectometry apparatus and the method for measuring the three-dimensional nanostructure on the flat substrate according to another embodiment. In the embodiment, the x-axis position of the 2-dimensional X-ray detector 106 may be not moved by fixing the x-axis moving device 112 during the measuring. The distance W between the X ray-reflection point 261 on the sample surface 230 and the surface 107 of the 2-dimensional X-ray detector 106 along the x-axis is constant and not varied during the measuring.

FIG. 2A is referred to. When the incident angle of the X-ray 350 with respect to the sample surface 230 is θ, the z-axis moving device 114 of the two-axis moving device 108 controls the 2-dimensional X-ray detector 106 to move on the z-axis with a formula: H=W·tan θ. By which the reflecting X-ray signal 352 can arrive at the center of the 2-dimensional X-ray detector 106 in the z-axis direction so as to be collected by the 2-dimensional X-ray detector 106. The 2-dimensional X-ray detector 106 still can collect the reflecting X-ray signal 352 with a moving deviation from the center of the 2-dimensional X-ray detector 106 in the z-axis direction being within ±L/2 during the measuring.

FIG. 2B is referred to. When the incident angle of the X-ray 350 with respect to the sample surface 230 is changed from θ(FIG. 2A) to θ+Δθ (FIG. 2B), the z-axis moving device 114 of the two-axis moving device 108 controls the 2-dimensional X-ray detector 106 to move on the z-axis with a formula: H+ΔH=tan(θ+Δθ). In other words, the z-axis moving device 114 controls the 2-dimensional X-ray detector 106 to move with a distance ΔH on the z-axis with a formula: ΔH=W·tan(θ+Δθ)−W·tan θ from the distance H. By which the reflecting X-ray signal 352 can arrive at the center of the 2-dimensional X-ray detector 106 in the z-axis direction so as to be collected by the 2-dimensional X-ray detector 106. The 2-dimensional X-ray detector 106 still can collect the reflecting X-ray signal 352 with a moving deviation from the center of the 2-dimensional X-ray detector 106 in the z-axis direction being within ±L/2 during the measuring.

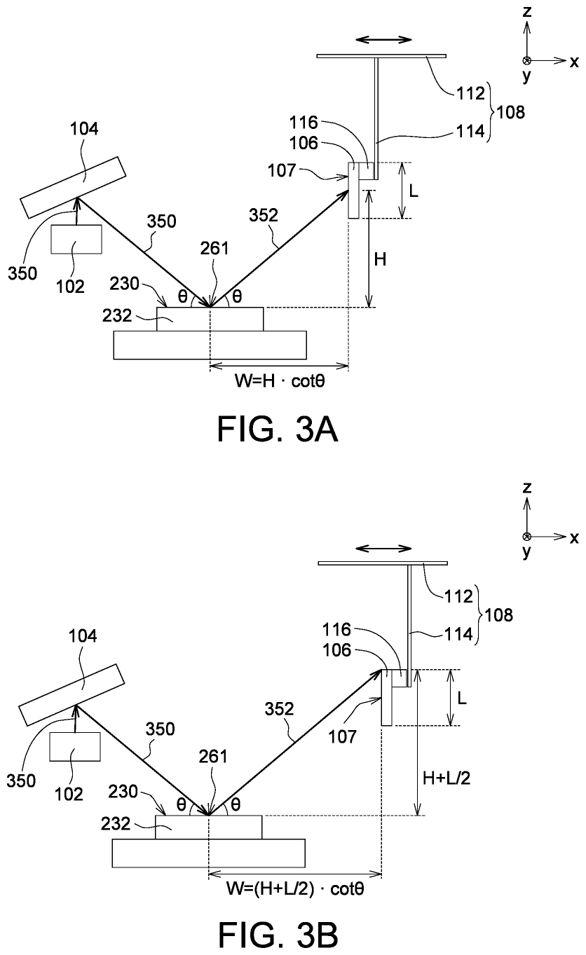

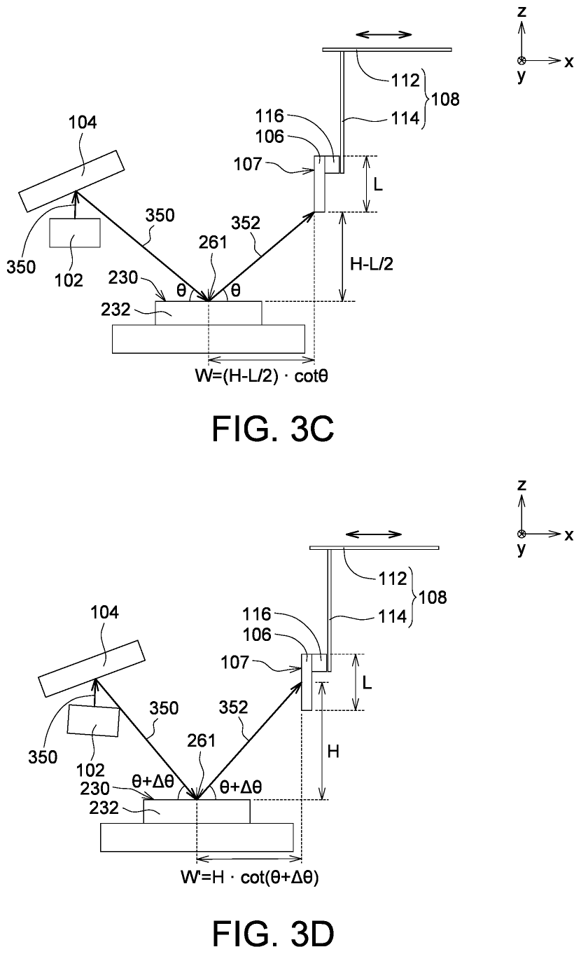

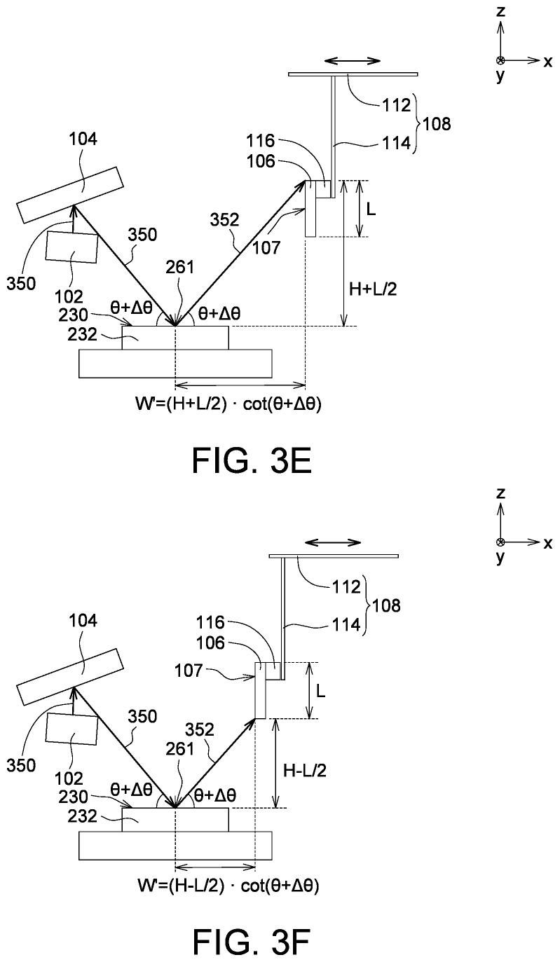

FIG. 3A and FIG. 3F illustrate the X-ray reflectometry apparatus and the method for measuring the three-dimensional nanostructure on the flat substrate according to yet another embodiment. In the embodiment, the z-axis position of the 2-dimensional X-ray detector 106 may be not moved by fixing the z-axis moving device 114 during the measuring. The distance H between the sample surface 230 and the center of the 2-dimensional X-ray detector 106 along the z-axis is constant and not varied during the measuring.

FIG. 3A is referred to. When the incident angle of the X-ray 350 with respect to the sample surface 230 is θ, the x-axis moving device 112 of the two-axis moving device 108 controls the 2-dimensional X-ray detector 106 to move on the x-axis with a formula: W=H·cot θ. By which the reflecting X-ray signal 352 can arrive at the center of the 2-dimensional X-ray detector 106 in the z-axis direction so as to be collected by the 2-dimensional X-ray detector 106. The 2-dimensional X-ray detector 106 still can collect the reflecting X-ray signal 352 within a distance range

$$( H - \frac{L}{2} ) \cdot cot θ$$

### (FIG. 3B) to

$$( H + \frac{L}{2} ) \cdot cot θ$$

(FIG. 3C) controlled by the x-axis moving device 112 during the measuring.

FIG. 3B is referred to. The formula

$${″}^{} ( H + \frac{L}{2} ) \cdot cot {θ}^{″}$$

is a maximum distance W between the X ray-reflection point 261 on the sample surface 230 and the surface 107 of the 2-dimensional X-ray detector 106 along the x-axis that the reflecting X-ray signal 352 can arrive at the top of the 2-dimensional X-ray detector 106 so as to be collected by the 2-dimensional X-ray detector 106. The distance between the top of the 2-dimensional X-ray detector 106 and the sample surface 230 along the z-axis is equal to H+L/2.

FIG. 3C is referred to. The formula

$${″}^{} ( H - \frac{L}{2} ) \cdot cot {θ}^{″}$$

is a minimum distance W between the X ray-reflection point 261 on the sample surface 230 and the surface 107 of the 2-dimensional X-ray detector 106 along the x-axis that the reflecting X-ray signal 352 can arrive at the bottom of the 2-dimensional X-ray detector 106 so as to be collected by the 2-dimensional X-ray detector 106. The distance between the bottom of the 2-dimensional X-ray detector 106 and the sample surface 230 along the z-axis is equal to H−L/2.

FIG. 3D is referred to. When the incident angle of the X-ray 350 with respect to the sample surface 230 is changed from θ (FIG. 3A) to θ+Δθ (FIG. 3D), the x-axis moving device 112 of the two-axis moving device 108 controls the 2-dimensional X-ray detector 106 to move on the x-axis with a formula: W′=W+ΔW=H·cot (θ+Δθ). In other words, the x-axis moving device 112 controls the 2-dimensional X-ray detector 106 to move with a distance ΔW on the x-axis with a formula: ΔW=H·cot (θ+Δθ)−H·cot θ from the distance W (FIG. 3A). By which the reflecting X-ray signal 352 can arrive at the center of the 2-dimensional X-ray detector 106 in the z-axis direction so as to be collected by the 2-dimensional X-ray detector 106. The 2-dimensional X-ray detector 106 still can collect the reflecting X-ray signal 352 within a distance range from

$$( H - \frac{L}{2} ) \cdot cot ( θ + Δθ )$$

### (FIG. 3F) to

$$( H + \frac{L}{2} ) \cdot cot ( θ + Δθ )$$

(FIG. 3E) during the measuring.

FIG. 3E is referred to. The formula

$${″}^{} ( H + \frac{L}{2} ) \cdot cot {( θ + Δθ )}^{″}$$

is a maximum distance W′ between the X ray-reflection point 261 on the sample surface 230 and the surface 107 of the 2-dimensional X-ray detector 106 along the x-axis that the reflecting X-ray signal 352 can arrive at the top of the 2-dimensional X-ray detector 106 so as to be collected by the 2-dimensional X-ray detector 106. The distance between the top of the 2-dimensional X-ray detector 106 and the sample surface 230 along the z-axis is equal to H+L/2.

FIG. 3F is referred to. The formula

$${″}^{} ( H - \frac{L}{2} ) \cdot cot {( θ + Δθ )}^{″}$$

is a minimum distance W′ between the X ray-reflection point 261 on the sample surface 230 and the surface 107 of the 2-dimensional X-ray detector 106 along the x-axis that the reflecting X-ray signal 352 can arrive at the bottom of the 2-dimensional X-ray detector 106 so as to be collected by the 2-dimensional X-ray detector 106. The distance between the bottom of the 2-dimensional X-ray detector 106 and the sample surface 230 along the z-axis is equal to H−L/2.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An X-ray reflectometry apparatus for measuring a three-dimensional nanostructure on a flat substrate, comprising:
an X-ray source for emitting X-ray;
an X-ray reflector configured for reflecting the X-ray onto a sample surface;
a 2-dimensional X-ray detector configured to collect a reflecting X-ray signal from the sample surface; and
a two-axis moving device configured to control two-axis directions of the 2-dimensional X-ray detector to move on at least one of x-axis and z-axis with a formula concerning an incident angle of the X-ray with respect to the sample surface for collecting the reflecting X-ray signal.

2. The X-ray reflectometry apparatus according to claim 1, wherein the two-axis moving device comprises an x-axis moving device and a z-axis moving device, wherein the x-axis moving device is configured to control the 2-dimensional X-ray detector to move on the x-axis, the z-axis moving device is configured to control the 2-dimensional X-ray detector to move on the y-axis.

3. The X-ray reflectometry apparatus according to claim 1, further comprising a rotating device configured for rotating the 2-dimensional X-ray detector in x-z plane.

4. The X-ray reflectometry apparatus according to claim 1, wherein when the incident angle of the X-ray with respect to the sample surface is set as a range from θ′ to θ′+Δθ, the two-axis moving device controls the 2-dimensional X-ray detector to move on the x-axis with a formula:
$$W < \frac{L}{tan ( {θ}^{′} + Δθ ) - tan {θ}^{′}} ,$$
wherein W is a distance between a X ray-reflection point on the sample surface and a surface of the 2-dimensional X-ray detector along the x-axis, L is a size of the 2-dimensional X-ray detector along the z-axis.

5. The X-ray reflectometry apparatus according to claim 1, wherein when the incident angle of the X-ray with respect to the sample surface is set as a range from θ′ to θ′+Δθ, the two-axis moving device controls the 2-dimensional X-ray detector to move on the z-axis with a formula: H=W·tan θ′+L/2, wherein W is a distance between a X ray-reflection point on the sample surface and a surface of the 2-dimensional X-ray detector along the x-axis, H is a distance between the sample surface and a center of the 2-dimensional X-ray detector along the z-axis, L is a size of the 2-dimensional X-ray detector along the z-axis.

6. The X-ray reflectometry apparatus according to claim 1, wherein when the incident angle of the X-ray with respect to the sample surface is set as a range from θ′ to θ′+Δθ, the two-axis moving device controls the 2-dimensional X-ray detector to move on the x-axis with a formula of
$$W < \frac{L}{tan ( {θ}^{′} + Δθ ) - tan {θ}^{′}} ,$$
and at the same time move on the z-axis with a formula of H=W·tan θ′+L/2, wherein W is a distance between a X ray-reflection point on the sample surface and a surface of the 2-dimensional X-ray detector along the x-axis, L is a size of the 2-dimensional X-ray detector along the z-axis, H is a distance between the sample surface and a center of the 2-dimensional X-ray detector along the z-axis.

7. The X-ray reflectometry apparatus according to claim 1, wherein when the incident angle of the X-ray with respect to the sample surface is θ, the two-axis moving device controls the 2-dimensional X-ray detector to move on the z-axis with a formula: H=W·tan θ, wherein W is a distance between a X ray-reflection point on the sample surface and a surface of the 2-dimensional X-ray detector along the x-axis, H is a distance between the sample surface and a center of the 2-dimensional X-ray detector along the z-axis.

8. The X-ray reflectometry apparatus according to claim 7, wherein a moving deviation of the 2-dimensional X-ray detector on the z-axis is within ±L/2, wherein L is a size of the 2-dimensional X-ray detector along the z-axis.

9. The X-ray reflectometry apparatus according to claim 7, wherein when the incident angle of the X-ray with respect to the sample surface is changed from θ to θ+Δθ, the two-axis moving device controls the 2-dimensional X-ray detector to move with a distance ΔH on the z-axis with a formula: ΔH=W·tan(θ+Δθ)−W·tan θ.

10. The X-ray reflectometry apparatus according to claim 9, wherein a moving deviation of the 2-dimensional X-ray detector on the z-axis is within ±L/2, wherein L is a size of the 2-dimensional X-ray detector along the z-axis.

11. The X-ray reflectometry apparatus according to claim 1, wherein when the incident angle of the X-ray with respect to the sample surface is set to be θ, the two-axis moving device controls the 2-dimensional X-ray detector to move on the x-axis with a formula: W=H·cot θ, wherein W is a distance between a X ray-reflection point on the sample surface and a surface of the 2-dimensional X-ray detector along the x-axis, H is a distance between the sample surface and a center of the 2-dimensional X-ray detector along the z-axis.

12. The X-ray reflectometry apparatus according to claim 11, wherein when the incident angle of the X-ray with respect to the sample surface is changed from θ to θ+Δθ, the two-axis moving device controls the 2-dimensional X-ray detector to move on the x-axis with a formula: W=H·cot (θ+Δθ).

13. The X-ray reflectometry apparatus according to claim 1, wherein when the incident angle of the X-ray with respect to the sample surface is set to be θ, the two-axis moving device controls the 2-dimensional X-ray detector to move on the x-axis within a distance range from
$$( H - \frac{L}{2} ) \cdot cot θ to ( H + \frac{L}{2} ) \cdot cot θ ,$$
wherein L is a size of the 2-dimensional X-ray detector along the z-axis, H is a distance between the sample surface and a center of the 2-dimensional X-ray detector along the z-axis,
$$( H + \frac{L}{2} ) \cdot cot θ$$
is a maximum distance between a X ray-reflection point on the sample surface and a surface of the 2-dimensional X-ray detector along the x-axis that the reflecting X-ray signal can arrive at the 2-dimensional X-ray detector,
$$( H - \frac{L}{2} ) \cdot cot θ$$
is a minimum distance between the X ray-reflection point on the sample surface and the surface of the 2-dimensional X-ray detector along the x-axis that the reflecting X-ray signal can arrive at the 2-dimensional X-ray detector.

14. The X-ray reflectometry apparatus according to claim 13, wherein when the incident angle of the X-ray with respect to the sample surface is changed from θ to θ+Δθ, the two-axis moving device controls the 2-dimensional X-ray detector to move on the x-axis within a distance range from
$$( H - \frac{L}{2} ) \cdot cot ( θ + Δθ ) to ( H + \frac{L}{2} ) \cdot cot ( θ + Δθ ) ,$$
wherein
$$( H + \frac{L}{2} ) \cdot cot ( θ + Δθ )$$
is a maximum distance between a X ray-reflection point on the sample surface and a surface of the 2-dimensional X-ray detector along the x-axis that the reflecting X-ray signal can arrive at the 2-dimensional X-ray detector,
$$( H - \frac{L}{2} ) \cdot cot ( θ + Δθ )$$
is a minimum distance between the X ray-reflection point on the sample surface and the surface of the 2-dimensional X-ray detector along the x-axis that the reflecting X-ray signal can arrive at the 2-dimensional X-ray detector.

15. A method for measuring a three-dimensional nanostructure on a flat substrate comprising:
emitting X-ray by an X-ray source;
reflecting the X-ray onto a sample surface by an X-ray reflector;
collecting a reflecting X-ray signal from the sample surface by a 2-dimensional X-ray detector; and
controlling two-axis directions of the 2-dimensional X-ray detector by a two-axis moving device to move on at least one of x-axis and z-axis with a formula concerning an incident angle of the X-ray with respect to the sample surface for collecting the reflecting X-ray signal.

16. The method according to claim 15, wherein the two-axis moving device comprises an x-axis moving device and a z-axis moving device, wherein the x-axis moving device is configured to control the 2-dimensional X-ray detector to move on the x-axis, the z-axis moving device is configured to control the 2-dimensional X-ray detector to move on the z-axis.

17. The method according to claim 15, further comprising rotating the 2-dimensional X-ray detector in x-z plane by a rotating device.

18. The method according to claim 15, wherein when the incident angle of the X-ray with respect to the sample surface is set as a range from θ′ to θ′+Δθ, the two-axis moving device controls the 2-dimensional X-ray detector to move on the x-axis with a formula:
$$W < \frac{L}{tan ( {θ}^{′} + Δθ ) - tan {θ}^{′}} ,$$
wherein W is a distance between a X ray-reflection point on the sample surface and a surface of the 2-dimensional X-ray detector along the x-axis, L is a size of the 2-dimensional X-ray detector along the z-axis.

19. The method according to claim 15, wherein when the incident angle of the X-ray with respect to the sample surface is set as a range from θ′ to θ′+Δθ, the two-axis moving device controls the 2-dimensional X-ray detector to move on the z-axis with a formula: H=W·tan θ′+L/2, wherein W is a distance between a X ray-reflection point on the sample surface and a surface of the 2-dimensional X-ray detector along the x-axis, H is a distance between the sample surface and a center of the 2-dimensional X-ray detector along the z-axis, L is a size of the 2-dimensional X-ray detector along the z-axis.

20. The method according to claim 15, wherein when the incident angle of the X-ray with respect to the sample surface is set as a range from θ′ to θ′+Δθ, the two-axis moving device controls the 2-dimensional X-ray detector to move on the x-axis with a formula of
$$W < \frac{L}{tan ( {θ}^{′} + Δθ ) - tan {θ}^{′}} ,$$
and at the same time move on the z-axis with a formula of H=W·tan θ′+L/2, wherein W is a distance between a X ray-reflection point on the sample surface and a surface of the 2-dimensional X-ray detector along the x-axis, L is a size of the 2-dimensional X-ray detector along the z-axis, H is a distance between the sample surface and a center of the 2-dimensional X-ray detector along the z-axis.

21. The method according to claim 15, wherein when the incident angle of the X-ray with respect to the sample surface is θ, the two-axis moving device controls the 2-dimensional X-ray detector to move on the z-axis with a formula: H=W·tan θ, wherein W is a distance between a X ray-reflection point on the sample surface and a surface of the 2-dimensional X-ray detector along the x-axis, H is a distance between the sample surface and a center of the 2-dimensional X-ray detector along the z-axis.

22. The method according to claim 21, wherein a moving deviation of the 2-dimensional X-ray detector on the z-axis is within ±L/2, wherein L is a size of the 2-dimensional X-ray detector along the z-axis.

23. The method according to claim 21, wherein when the incident angle of the X-ray with respect to the sample surface is changed from θ to θ+Δθ, the two-axis moving device controls the 2-dimensional X-ray detector to move with a distance ΔH on the z-axis with a formula: ΔH=W·tan(θ+Δθ)−W·tan θ.

24. The method according to claim 23, wherein a moving deviation of the 2-dimensional X-ray detector on the z-axis is within ±L/2, wherein L is a size of the 2-dimensional X-ray detector along the z-axis.

25. The method according to claim 15, wherein when the incident angle of the X-ray with respect to the sample surface is set to be θ, the two-axis moving device controls the 2-dimensional X-ray detector to move on the x-axis with a formula: W=H·cot θ, wherein W is a distance between a X ray-reflection point on the sample surface and a surface of the 2-dimensional X-ray detector along the x-axis, H is a distance between the sample surface and a center of the 2-dimensional X-ray detector along the z-axis.

26. The method according to claim 25, wherein when the incident angle of the X-ray with respect to the sample surface is changed from θ to θ+Δθ, the two-axis moving device controls the 2-dimensional X-ray detector to move on the x-axis with a formula: W=H·cot (θ+Δθ).

27. The method according to claim 15, wherein when the incident angle of the X-ray with respect to the sample surface is set to be θ, the two-axis moving device controls the 2-dimensional X-ray detector to move on the x-axis within a distance range from
$$( H - \frac{L}{2} ) \cdot cot θ to ( H + \frac{L}{2} ) \cdot cot θ ,$$
wherein L is a size of the 2-dimensional X-ray detector along the z-axis, H is a distance between the sample surface and a center of the 2-dimensional X-ray detector along the z-axis,
$$( H + \frac{L}{2} ) \cdot cot θ$$
is a maximum distance between a X ray-reflection point on the sample surface and a surface of the 2-dimensional X-ray detector along the x-axis that the reflecting X-ray signal can arrive at the 2-dimensional X-ray detector,
$$( H - \frac{L}{2} ) \cdot cot θ$$
is a minimum distance between the X ray-reflection point on the sample surface and the surface of the 2-dimensional X-ray detector along the x-axis that the reflecting X-ray signal can arrive at the 2-dimensional X-ray detector.

28. The method according to claim 27, wherein when the incident angle of the X-ray with respect to the sample surface is changed from θ to θ+Δθ, the two-axis moving device controls the 2-dimensional X-ray detector to move on the x-axis within a distance range from
$$( H - \frac{L}{2} ) \cdot cot ( θ + Δθ ) to ( H + \frac{L}{2} ) \cdot cot ( θ + Δθ ) ,$$
wherein
$$( H + \frac{L}{2} ) \cdot cot ( θ + Δθ )$$
is a maximum distance between a X ray-reflection point on the sample surface and a surface of the 2-dimensional X-ray detector along the x-axis that the reflecting X-ray signal can arrive at the 2-dimensional X-ray detector,
$$( H - \frac{L}{2} ) \cdot cot ( θ + Δθ )$$
is a minimum distance between the X ray-reflection point on the sample surface and the surface of the 2-dimensional X-ray detector along the x-axis that the reflecting X-ray signal can arrive at the 2-dimensional X-ray detector.
